(19) United States
(12) Patent Application Publication
(10) Pub. No.: US 2009/0030683 A1
(43) Pub. Date: Jan. 29, 2009

(54) SYSTEM AND METHOD FOR TRACKING DIALOGUE STATES USING PARTICLE FILTERS

(75) Inventor: Jason WILLIAMS, New York, NY (US)

Correspondence Address: AT&T CORP., ROOM 2A207, ONE AT&T WAY, BEDMINSTER, NJ, 07921, US

(73) Assignee: AT&T Labs, Inc, Austin, TX (US)

(21) Appl. No.: 11/828,633

(22) Filed: Jul. 26, 2007

(51) Int. Cl. G10L 15/00

(52) U.S. Cl. 704/236; 704/E15.001

(57) ABSTRACT

Disclosed are methods, systems, and computer-readable media for tracking dialog states in a spoken dialog system. The method comprises casting a plurality of dialog states, or particles, as a network describing the probability relationships between each of a plurality of variables, sampling a subset of the plurality of dialog states, or particles, in the network, for each sampled dialog state, or particle, projecting into the future, assigning a weight to each sampled particle, and normalizing the assigned weights to yield a new estimated distribution over each variable's values, wherein the distribution over the variables is used in a spoken dialog system. Also disclosed is a method of tuning performance of the methods, systems, and computer-readable media by adding or removing particles to/from the network.

### BACKGROUND OF THE INVENTION

1. Field of the Invention

The present invention relates generally to dialog systems and more specifically to approximating probabilities of multiple dialog states using particle filters.

2. Introduction

Traditional dialog systems maintain a single hypothesis of the dialog state. Recently, methods of maintaining a distribution over dialog states have been shown to yield better performance, including decision theoretic methods, M-Best lists, and Partially Observable Markov Decision Processes (POMDPs). The intuition is that a distribution over dialog states directly models both the errors introduced during speech recognition and the variability of the user's responses, which allows it to account for all possible dialog histories given the evidence, and thus to choose actions optimally.

Past research has assumed that essentially one persistent hidden variable exists—the user's goal—and that this variable is fixed throughout the dialog. This is a significant logical limitation because a plurality of hidden persistent variables may exist. Further, the multiple persistent variables may change state throughout the dialog. In a troubleshooting example in which a dialog system helps a user to troubleshoot a product such as a failed Digital Subscriber Loop (DSL) connection, numerous persistent hidden variables exist, such as the power state of the DSL modem, whether the username has been entered correctly, whether there is a service outage, and whether the network cable is connected correctly. These variables are interrelated and continuously changing state throughout the dialog. Indeed, the goal of the dialog system is to guide each of the variables into a working state. Updating the belief over all of these constantly-changing variables quickly becomes impossible in real-time, and the dialog literature has not tackled this problem.

In general, a dialog system may be framed as a Bayesian network consisting of the tuple (S, O, A, T, Z, b₀). A represents the set of actions available to the dialog system (such as asking a question or consulting a database). O represents the set of observations the system may make about its environment (such as output from the ASR and understanding process or a database result). S represents the space of possible dialog states, and in practice is usually decomposed into a number of components which track, for example, the user's goal, the user's actions, and/or the dialog history. T provides a model of how the dialog state changes in response to system actions P(s′|s, a), and Z provides a model of how the observations relate to the system state P(o′|s′, a). Lower case letters indicate an element in the set represented by the capital letter (i.e. s is a member of the set S, etc.).

A key property of spoken dialog systems is that the observation o provides noisy and incomplete information about the state of the dialog s, and the Bayesian network accounts for this by tracking a distribution over dialog states b(s) called a belief state, with initial belief b₀. At each time-step, b is updated as

$${b}^{′} ( {s}^{′} ) = η \cdot ( {o}^{′} \vert {s}^{′} , a ) {\sum }_{s} P ( {s}^{′} \vert s , a ) b ( s ) \qquad ( Equation 1 )$$

where η is a normalization constant. The process of maintaining b at each time step is called belief monitoring.

The belief state b is used at run-time to select a system action using some policy π: b→a. This policy can be produced using techniques such as POMDPs, decision-theory, or by hand crafting. The method used is not important; the key point is that all probabilistic techniques rely on being able to compute b(s) in real time, as the dialog is progressing.

When the number of possible dialog states |S| is small, the update in equation 1 is straightforward. However, for dialog systems of a realistic size, the number of possible dialog states can be very large. Since the dialog state s is typically decomposed into components s=(s₁, s₂, . . . , s_{N}) where s is an element of the set Sᵢ, the total number of dialog states is πᵢ |Sᵢ|, which grows exponentially in the number of components.

Past work has focused on the slot-filling domain and concentrated on growing the number of distinct values that a single variable—the user's goal—can take on. Researchers assume that each slot sᵢ can be tracked independently, avoiding computing a joint distribution over (s₁, s₂, . . . , s_{N}). Other techniques have been developed which can track a distribution user's goal precisely, without approximation, provided that the user's goal is not changing. Alternatively, an M-Best list of dialog states can be used to approximate a distribution over all possible dialog states by enumerating only the hypotheses which are suggested by the ASR N-Best list, but M-Best lists are limited in several ways. First, an M-Best list is only viable when a dialog contains a small number of fields. Second, while it is straightforward to maintain a score assigned to an individual element on the list, it is difficult to maintain the amount of probability left off the list, which is important because the dialog system needs to know how likely a single entry is relative to all other possible dialog states, not just the other dialog states which happen to be on the list.

By assuming that the user's goal is the only persistent element of hidden state and that its value is fixed, past work has successfully reduced complexity of the belief update process. In other words, past work has shown how to perform belief monitoring when there is a single persistent variable which takes on a fixed value. In many real-world applications, basing belief monitoring on a single unchanging user goal is inadequate.

Accordingly, what is needed in the art is an improved way of belief monitoring when there are many constantly changing variables in a dialog system while remaining feasible for real-time use.

### SUMMARY OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

The invention includes methods, systems, and computer-readable media for tracking dialog states in a spoken dialog system. The method comprises casting a plurality of dialog states, or particles, as a network describing the probability relationships between each of a plurality of variables, sampling a subset of the plurality of dialog states, or particles, in the network, for each sampled dialog state, or particle, projecting into the future, assigning a weight to each sampled particle, and normalizing the assigned weights to yield a new estimated distribution over each variable's values, wherein the distribution over the variables is used in a spoken dialog system. Also disclosed is a method of tuning performance and accuracy of the methods, systems, and computer-readable media by adding or removing one or more particles from the network.

This invention is a new approach to belief monitoring in dialog systems which allows the number of variables to be scaled. Particle filters, also known as Sequential Monte Carlo methods, are a mathematical technique originally developed by experimental physicists which have been successfully applied to robotic navigation. Particle filters have not, as yet, been applied to dialog systems. In simple terms, a particle filter aims to estimate a sequence of hidden parameters, based only on observed data. The dialog state is cast as a network comprised of particles and a particle filter performs approximate, rather than exact, updates. A particle filter is a general-purpose technique for approximating inference in networks, including Bayesian networks. Given a distribution over dialog states, particles are sampled, each particle representing a possible dialog state. For each particle, a successor particle in the next time-step is then sampled, and is weighted by the likelihood that it would produce the speech recognition result. This weighted set of particles is normalized to yield a new estimated distribution over dialog states.

Adjusting the number of particles represents a trade-off between speed and accuracy; as particles are added, the belief estimate (and accuracy) improves at the expense of additional computation. Computing all possible particles computes all possible combinations of values and variables, guaranteeing an optimal, exact result, but takes prohibitively long in real-world situations. This allows the method to be “tuned” to produce a response within a specified time, to produce a response with a certain threshold of certainty, or to achieve other goals.

Particle filters have been applied to belief monitoring for POMDPs in the past. The need for an approximation in that work is to allow real-valued quantities to be used in the state (a position vector); here the aim is to handle many interrelated discrete variables.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a basic system or computing device embodiment of the invention;

FIG. 2 illustrates a sample set of variables used in a POMDP-based troubleshooting dialog system;

FIG. 3 illustrates a particle-based network demonstrating how the variables and values of FIG. 2 could be arranged;

FIG. 4 illustrates the average error rate in state estimates for various numbers of particles in the sample set of FIG. 2;

FIG. 5 illustrates the number of particles vs. the average dialog length and task completion rate of the sample set of FIG. 2;

FIG. 6 illustrates the performance of particle filter monitoring vs. exact belief monitoring using the sample set of FIG. 2;

FIG. 7 illustrates the number of particles vs. the response time using the sample set of FIG. 2; and

FIG. 8 illustrates a method embodiment of the invention.

### DETAILED DESCRIPTION OF THE INVENTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

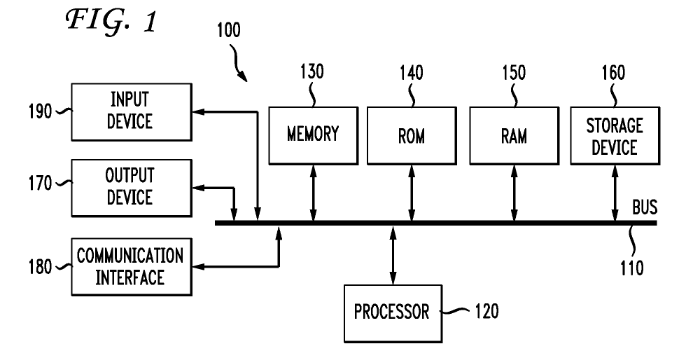

With reference to FIG. 1, an exemplary system for implementing the invention includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS), containing the basic routine that helps to transfer information between elements within the computing device 100, such as during start-up, is typically stored in ROM 140. The computing device 100 further includes storage means such as a hard disk drive 160, a magnetic disk drive, an optical disk drive, tape drive or the like. The storage device 160 is connected to the system bus 110 by a drive interface. The drives and the associated computer-readable media provide nonvolatile storage of computer-readable instructions, data structures, program modules and other data for the computing device 100. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer-readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch sensitive screen for gesture or graphical input, keyboard, mouse, motion input, speech and so forth. The input may be used by the presenter to indicate the beginning of a speech search query. The device output 170 can also be one or more of a number of output means. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative embodiment of the present invention is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

At a high level, this invention is a way to predict or approximate paths through unknown dialog states. In a spoken dialog system, the beginning variable states are not known, but a distribution of probability over each element may be estimated. In the DSL troubleshooting model below, for example, a customer calling DSL technical support may have a 20% chance that the modem connection light is on. Each variable state has a certain probability which may be assigned to it. The desired ending variable states are known, but the exact configuration of variables and values is not known. Dialog states are framed in a network; the examples use Bayesian networks. Each dialog state in the network is called a particle. Particles can have certain weights assigned to them. The weights are assigned to the particles using a particle filter method, a general purpose method for estimating a sequence of hidden parameters in the network. While it is not a precise determination, using a sufficient sample size allows for a very small margin of error between the approximation and a precise determination while significantly reducing compute time, some tests yielding a reduction from 48 seconds to 3.5 seconds of execution time.

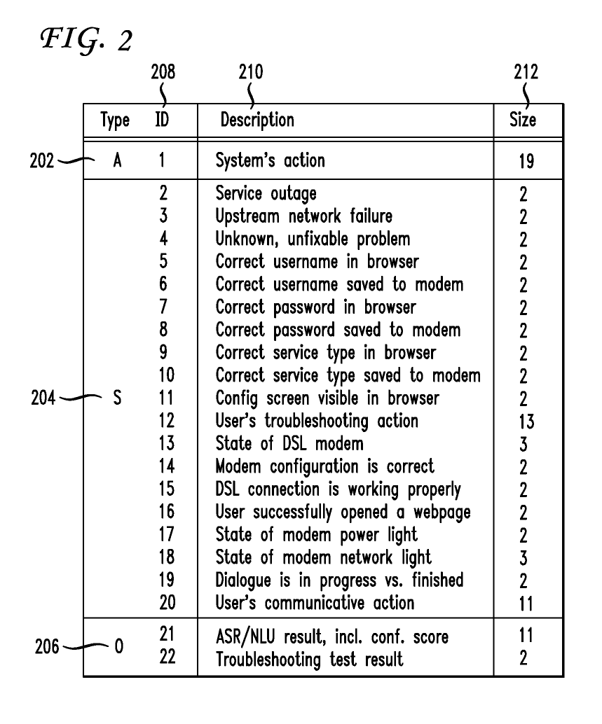

FIGS. 2-7 are modeled on a spoken dialog system for helping users restore a failed DSL connection. The dialog models were handcrafted based on interviews with DSL technicians. Most of the models are deterministic; for example, if the power to the DSL modem is off (ID 13 on FIG. 2), then the power and network lights will both be off (IDs 17 and 18 on FIG. 2). The dialog models are stochastic and are estimated from annotated conversations with DSL technicians. While a DSL troubleshooting example is discussed, the invention may also apply to other situations, such as an automated speech-based tool in fixing a refrigerator, fixing a car, a rudimentary legal question answering service, directory assistance, information kiosk, hotel reservations, medical diagnosis, or virtually any other automated spoken dialog system. In the case of a typical refrigerator which provides little feedback, fewer variables are involved than a DSL modem which provides feedback in the form of lights, a web interface, replying to pings, etc. A car may provide even more diagnostic feedback through beeps, audio prompts, lights, output to specialized computerized diagnostic tools, a graphic presentation on a screen, or any combination. Diagnosing and fixing a car may include many more variables in the network than fixing a DSL modem does. The number of variables or particles included in the network does not affect the applicability of the invention, although significant changes in the formulation of the network may increase the number of sampled particles required to closely approximate the correct distribution over hidden dialog states.

FIG. 2 illustrates a sample set of variables representing 19 components of the dialog state and 2 observation components used in a POMDP-based troubleshooting dialog system, as applied to a DSL troubleshooting example. The sample set of variables is presented as a table sorted by variable type. Type A 202 includes action variables, such as the system's action. Type S 204 includes state variables. Most of the state variables in this example tend to be Boolean (on/off) type variables, but this should not be understood as a limitation on the invention. In some cases, the state variables may contain more information than a Boolean type variable, such as distance, volume, or other quantifiable attribute having more than 2 discrete states. Type O 206 includes observation variables. Each variable in the table has a unique ID 208, a description 210, and a size or weight 212. The unique IDs may be one way to indicate variable types like A 202, S 204, and O 206. For example, Type A action variables could have unique IDs in the 10,000-19,999 range, Type S state variables could have unique IDs in the 20,000-29,999 range, and Type O observation variables could have unique IDs in the 30,000-39,999 range. While the descriptions are not required to be unique, for the sake of keeping the descriptions relevant and understandable by humans, the descriptions may be most useful if they are unique in practice.

The models of the product behavior in FIG. 2 were handcrafted based on interviews with DSL technicians, and most of these models are deterministic: for example, if the power to the DSL modem is off (node 13), then the power and network lights will both be off (nodes 17 and 18). The models of user behavior are stochastic and are estimated from annotated conversations between users and DSL technicians. Concept recognition errors were generated with p=0.30, and confidence scores were drawn from an exponential distribution such that at an equal error rate confidence threshold about half of the concept errors could be identified.

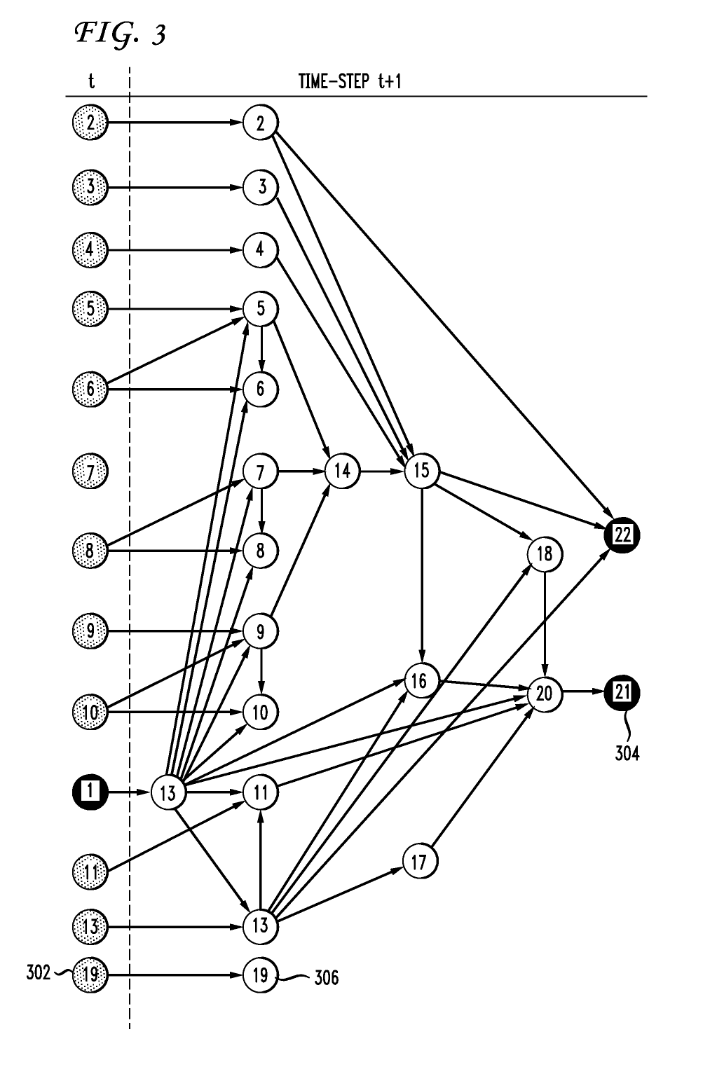

FIG. 3 illustrates a particle-based network showing the DSL troubleshooting dialog system of FIG. 2. Gray nodes/particles 302 contain “soft” evidence in the form of a probability distribution. Black nodes/particles 304 contain “hard” evidence, or a known value. White nodes/particles 306 are hidden; their value is unknown. The aim of the belief updating process is to infer the posterior distributions over the white nodes/particles between the gray and the black nodes/particles.

As described in equation 1, belief monitoring requires iterating over all values of the state. Unfortunately, standard techniques for passing evidence through the network incrementally (such as Junction Trees) are not of help here. FIG. 3 shows the network as an influence diagram and helps make this clear. Because evidence exists at both the root nodes and leaf nodes, and because there are multiple paths from root to leaf, it is not possible to form small cliques. In order to perform belief monitoring, the system is forced to compute the joint distribution.

In a test dialog system, computing this joint probability distribution required between 13s and 48s, which is clearly too slow for a spoken dialog system. The response time varies because, at certain points in the dialog, a variable's value may be known with certainty and this can be used to speed up belief monitoring. For example, if a DSL modem responds to a ping, then there is definitely not a service outage and that possibility can be marked as impossible or very improbable, freeing up processing time for more probable possibilities.

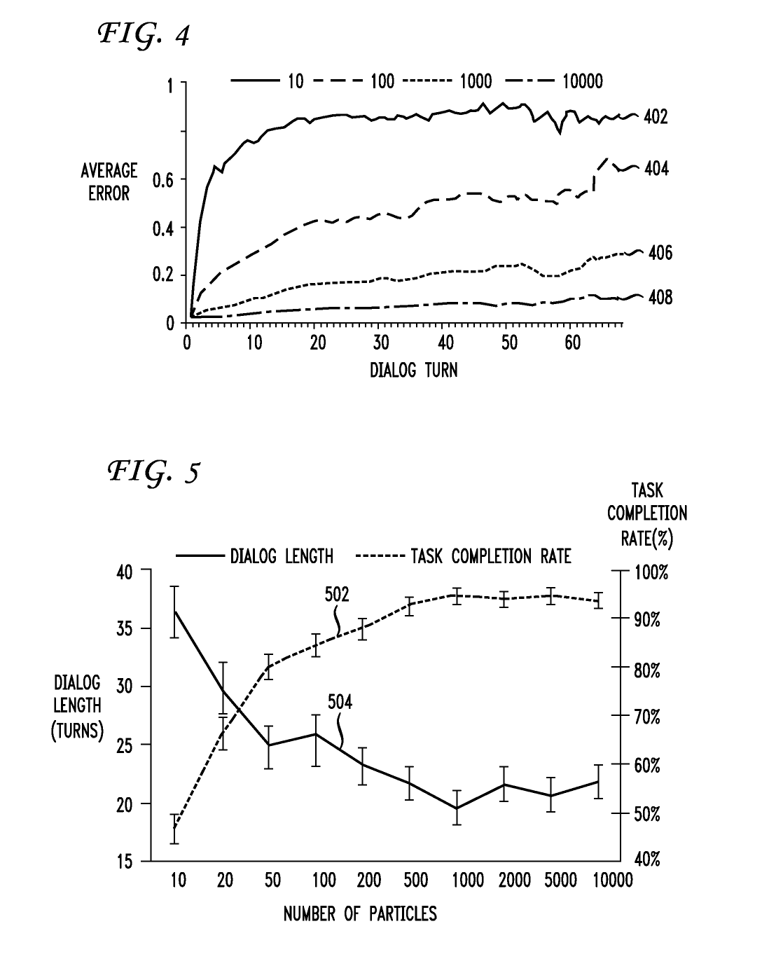

FIGS. 4-7 illustrate the accuracy results of an evaluation of this method. 500 simulated dialogs were produced using exact belief monitoring, and the exact belief states for each variable at each time-step were computed. Next, the sequence of system actions and observations was provided to the particle filter method, and its estimate of belief of each variable at each time-step was obtained. For each time-step in each dialog, the exact and estimated belief states were compared for each variable, and the maximum L1 error across all variables was computed. These L1 errors were averaged across dialogs to obtain an average error per time-step.

FIG. 4 illustrates the average error rate in state estimates for various numbers of particles. The line representing using 10 particles 402 shows the error quickly rising to nearly its upper bound of 1.0, indicating a complete misestimate of the belief in at least one the variable values. Lines representing using 100 particles 404, 1000 particles 406, and 10,000 particles 408 show that as particles used increases, the average error decreases. As has been found in other domains such as robotics, the error appears to plateau after a few dialog turns rather than steadily growing. This is an important result because it indicates that the error is likely to remain constant over the course of the dialog rather than steadily increasing, suggesting the method is suitable for both long and short dialogs.

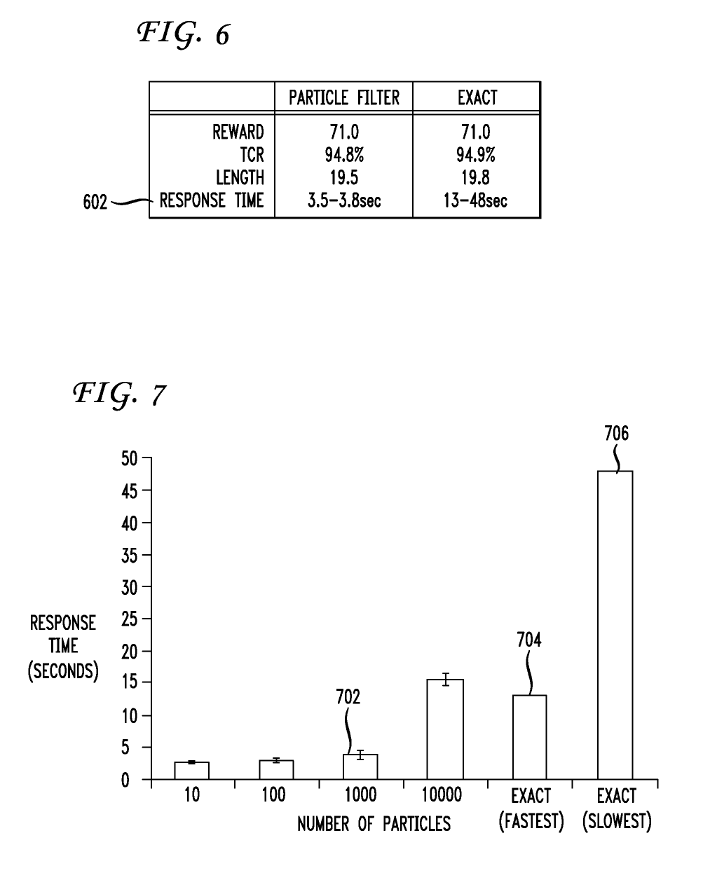

FIG. 5 illustrates the number of particles vs. the average dialog length and task completion rate. In practice the estimation error is not important, but rather the performance of the spoken dialog system in terms of task completion rate and dialog length. In other words, estimation error is only significant if it impacts performance. To assess this, dialogs were run using approximate belief monitoring for various numbers of particles. Results are shown in FIG. 5. As the number of particles is increased from 10 to 10,000, task completion rate 502 increases and dialog length 504 decreases to an asymptote. Performance begins to plateau at 1000 particles. Performance for 1000 particles is shown alongside several baselines in FIG. 6, which illustrates the performance results of particle filter monitoring vs. exact belief monitoring.

The table of FIG. 6 shows estimation results of particle filter that used 1000 particles as compared with the exact results. TCR in FIG. 6 stands for Task Completion Rate. Dialog length is measured in turns. Reward, TCR, and dialog length are measured over 1000 simulated dialogs. Response time shows the range of the fastest to slowest responses over a single dialog as performed on the same hardware. FIG. 6 demonstrates that in every measured factor except for Response Time 602, the results are essentially the same, definitely within a reasonable margin of error. In Response Time, the particle filter estimation finished faster by 9.2 to 44.5 seconds than the time required for the exact calculation.

FIG. 7 illustrates the number of particles vs. the response time. The troubleshooting spoken dialog system was switched from simulation mode to interactive mode, and a dialog was run using various numbers of particles. The time between the end of the user's speech and the beginning of the system response was measured. During this time, the test dialog system was performing recognition, the belief state update, action selection, and text-to-speech generation. Results are shown in FIG. 7. In this test dialog system, the bar showing results from using 1000 particles 702 yielded an acceptable response time under 4 seconds, and is a significant improvement over exact belief monitoring which had a response time ranging from approximately 14 seconds 704 to 50 seconds 706.

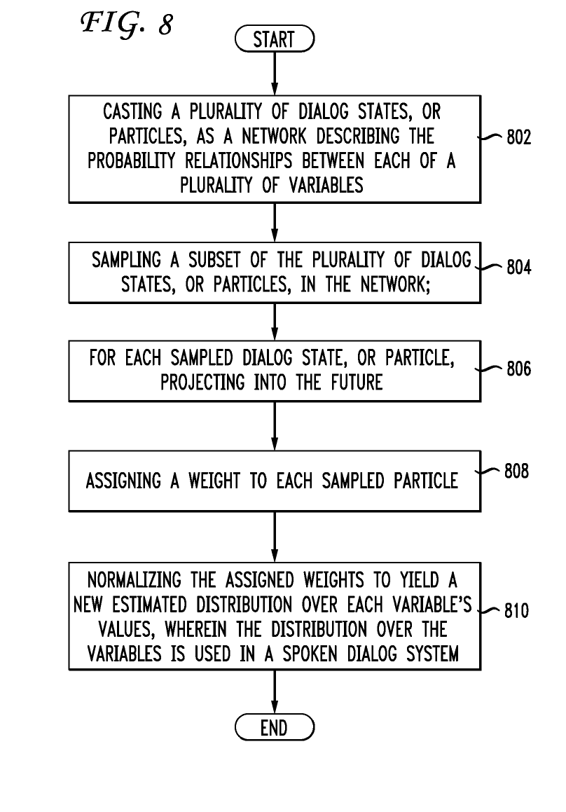

FIG. 8 illustrates a method embodiment of the invention. First, the method casts a plurality of dialog states, or particles, as a network describing the probability relationships between each of a plurality of variables (802). The network may be a Bayesian network. Second, the method samples each of the plurality of dialog states, or particles, in the network (804). Third, the method projects into the future for each sampled dialog state, or particle (806). In detail, the hidden dialog state s consists of components S=(s₁, s₂, . . . , s_{N}) and the observation consists of components o=(o₁, o₂, . . . , o_{M}). In this notation, sᵢ is a variable which takes on values s¹ᵢ, s²ᵢ, . . . . It is assumed that the joint belief state b(s₁, s₂, . . . , s_{N}) is too large to maintain and rather the marginals b₁(s₁), b₂(s₂), . . . b_{N}(s_{N}) are maintained. The observation (o₁, o₂, . . . , o_{M}) and the system action a are given and the task is to compute the new belief state b′₁(s₁), b′₂(s₂), . . . , b∝_{N}(s_{N}).

Fourth, the method assigns a weight to each sampled dialog state, or particle (808). To perform the update, values are sampled from the network. First, values of s₁, s₂, . . . , s_{N} are sampled according to b₁(s₁), b₂(s₂), . . . , b_{N}(s_{N}). Next, values of s′₁, s′₂, . . . s′_{N} are sampled according to the conditional probability tables for each variable as specified by the network. The result is an instantiation of (s,s′) which is referred to as a “particle” p=(s,s′). Next, p(o′s′, a) is computed using the value of s′ in the particle, the observation o′ received and the system action a. This value is called the “particle weight”, w. This process is repeated X times to produce a set of particles pₓ and their weights wₓ.

Finally, the method normalizes the assigned weights to yield a new estimated distribution over dialog states, wherein the normalized assigned weights are used in a spoken dialog system. (810). In this step, the particle weights are normalized, and the new estimated marginals over each variable's values are computed by summing the normalized weights:

$${b}_{i}^{2} ( {s}_{i}^{{j}^{′}} ) {\sum }_{x \text{:} {p}_{x} ( {s}_{i} ) - {s}_{i}^{j}} {w}_{x} \qquad ( Equation 2 )$$

As the number of particles approaches infinity, the error in the approximation approaches zero under mild assumptions. The amount of computation and storage required both grow linearly with the number of particles. In other words, the number of particles sets the trade-off between speed and accuracy—as particles are added, the belief estimate improves at the expense of additional computation time. This allows the method to be tuned to deliver a response within a specified time, which is an important property in a real-time environment such as a dialog system. The tuning may be done dynamically, in real-time, both, or neither. One example of tuning could be a time-sensitive system where responses are desired in 2 seconds or less. The system could be tuned to analyze as much as possible in 2 seconds and return the best result found up to that point. While the returned results may not be the absolute best option, in a time-critical system the trade-off of accuracy for execution speed may be necessary. As another example, if a particular problem domain was particularly error-prone, a more comprehensive analysis could be employed to only return a result after a minimum number of particles or dialog states have been analyzed. In a human interactive context, a user could be presented with a progress indicator which shows the user the analysis progress. The progress indicator may take the form of a graphical display (a progress bar for example or text on a screen), an audio prompt (a beep or a natural language prompt), tactile feedback (vibration, moving an object, changing temperature, etc.), or any combination. The user may be able to exercise judgment to select a satisfactory point in time, based on accuracy or speed or whatever other factor a user might wish, at which point the best result found so far is returned.

In testing the method, a problem occurred when running with very small numbers of particles. Occasionally observations which were always reliable (such as a network test operation) caused all particles to receive zero weight. This happened when a speech recognition error earlier in the dialog caused the correct (though unlikely) dialog state for a variable to become zero and lead to a divide by zero. One way to solve this problem is to prevent the belief bᵢ (s^{j}ᵢ) to go below a threshold or to ensure that the belief bᵢ (s^{j}ᵢ) is always greater than 0. Experimentation showed that a threshold of 1/(X*|Sᵢ|) works well in practice, and each variable value was always allocated at least this much mass. Since the reserved mass approaches zero as the number of particles approaches infinity, this variation does not change the asymptotic accuracy of the estimate. Any suitable predetermined positive number threshold could be used, instead of the calculated threshold of 1/(X*|Sᵢ|), given that the threshold number is less than 1/|Sᵢ| and that it approaches zero as the number particles approaches infinity.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. For example, the invention could be used to evaluate, train, or improve other dialog systems or the invention could be used in foreign language dialogs. Accordingly, the appended claims and their legal equivalents should only define the invention, rather than any specific examples given.

I claim:

1. A method of tracking dialog states in a spoken dialog system, the method comprising:
casting a plurality of dialog states, or particles, as a network describing the probability relationships between each of a plurality of variables;
sampling a subset of the plurality of dialog states, or particles, in the network;
for each sampled dialog state, or particle, projecting into the future;
assigning a weight to each sampled particle; and
normalizing the assigned weights to yield a new estimated distribution over each variable's values, wherein the distribution over the variables is used in a spoken dialog system.

2. The method of claim 1, wherein performance may be tuned by adding one or more particles to improve accuracy, or removing one or more particles to reduce compute time.

3. The method of claim 2, wherein a determination to add or remove one or more particles is dynamically determined.

4. The method of claim 2, wherein a determination to add or remove one or more particles is made in real-time.

5. The method of claim 2, wherein human interaction determines how many particles to add or remove.

6. The method of claim 1, wherein the network is an arbitrary Bayesian network.

7. The method of claim 1, wherein each assigned weight does not go below a threshold, the threshold being greater than zero.

8. The method of claim 1, wherein assigned particle weights are determined by a likelihood of generating observable evidence.

9. A system of tracking dialog states in a spoken dialog system, the system comprising:
a module configured to cast a plurality of dialog states, or particles, as a network describing the probability relationships between each of a plurality of variables;
a module configured to sample a subset of the plurality of dialog states, or particles, in the network;
a module configured to project into the future for each sampled dialog state, or particle;
a module configured to assign a weight to each sampled particle; and
a module configured to normalize the assigned weights to yield a new estimated distribution over each variable's values, wherein the distribution over the variables is used in a spoken dialog system.

10. The system of claim 9, wherein performance may be tuned by adding one or more particles are added to improve accuracy, or removing one or more particles to reduce compute time.

11. The system of claim 10, wherein a determination to add or remove one or more particles is dynamically determined.

12. The system of claim 10, wherein a determination to add or remove one or more particles is made in real-time.

13. The system of claim 9, wherein the network is an arbitrary Bayesian network.

14. The system of claim 9, wherein each assigned weight does not go below a threshold, the threshold being greater than zero.

15. The system of claim 9, wherein assigned particle weights are determined by a likelihood of generating observable evidence.

16. A computer-readable medium storing a computer program having instructions for tracking dialog states in a spoken dialog system, the instructions comprising:
casting a plurality of dialog states, or particles, as a network describing the probability relationships between each of a plurality of variables;
sampling a subset of the plurality of dialog states, or particles, in the network;
for each sampled dialog state, or particle, projecting into the future;
assigning a weight to each sampled particle; and
normalizing the assigned weights to yield a new estimated distribution over each variable's values, wherein the distribution over the variables is used in a spoken dialog system.

17. The computer-readable medium of claim 16, wherein performance may be tuned by adding one or more particles are added to improve accuracy, or removing one or more particles to reduce compute time.

18. The computer-readable medium of claim 17, wherein a determination to add or remove one or more particles is dynamically determined.

19. The computer-readable medium of claim 17, wherein a determination to add or remove one or more particles is made in real-time.

20. The computer-readable medium of claim 16, wherein the network is an arbitrary Bayesian network.

21. The computer-readable medium of claim 16, wherein each assigned weight does not go below a threshold, the threshold being greater than zero.

22. The computer-readable medium of claim 16, wherein assigned particle weights are determined by a likelihood of generating observable evidence.
